(19) United States
(12) Patent Application Publication
(10) Pub. No.: US 2010/0106650 A1
(43) Pub. Date: Apr. 29, 2010

(54) JOINTLY AUCTIONING EXPIRING DOMAIN NAMES

(75) Inventors: Warren Adelman, Scottsdale, AZ (US); Tim Ruiz, Cedar Rapids, IA (US)

Correspondence Address: GO DADDY GROUP, INC., 14455 NORTH HAYDEN ROAD, SUITE 219, SCOTTSDALE, AZ, 85260, US

(73) Assignee: THE GO DADDY GROUP, INC., Scottsdale, AZ (US)

(21) Appl. No.: 12/260,881

(22) Filed: Oct. 29, 2008

(51) Int. Cl. G06Q 30/00; G06F 15/173; G06Q 50/00

(52) U.S. Cl. 705/80; 709/224; 705/26

(57) ABSTRACT

Methods of the present inventions allow for jointly auctioning expiring domain names. An exemplary method may comprise determining (perhaps by a server) whether a domain name's registration may expire within a predetermined timeframe. If it is determined that the registration will expire within the timeframe, the domain name registrant may be contacted (prior to the domain name's expiration) to request an agreement to jointly sell the domain name and to share the resultant sales fee. If the parties agree, the domain name may then be sold (perhaps via a server) to a third party and the resultant fee may be shared with the registrant.

### CROSS REFERENCE TO RELATED PATENT APPLICATIONS

This patent application is related to U.S. patent application Ser. No. ______ entitled: “Systems for Jointly Auctioning Expiring Domain Names” concurrently filed herewith and also assigned to The Go Daddy Group, Inc.

### FIELD OF THE INVENTION

The present inventions generally relate to the field of the Internet and, more specifically, methods and systems for jointly auctioning expiring domain names.

### SUMMARY OF THE INVENTION

An example embodiment of a method for jointly auctioning expiring domain names may comprise determining (perhaps by a server) whether a domain name's registration may expire within a predetermined timeframe. If it is determined that the registration will expire within the timeframe, the domain name registrant may be contacted (prior to the domain name's expiration) to request an agreement to jointly sell the domain name and to share the resultant sales fee. If the parties agree, the domain name may then be sold to a third party and the resultant fee may be shared with the registrant.

An example embodiment of a system for jointly auctioning expiring domain names may comprise a server configured to: (1) determine whether a domain name's expiration date is within a predetermined timeframe (perhaps by searching a registered domain names database); and (2) contact the domain name's registrant to request an agreement to jointly sell the domain name and to share the resultant sales fee. The system also may comprise an expiring domain names database storing domain names having registrations expiring within the predetermined timeframe. A domain name sales website (that may list for sale some of the expiring domain names stored in the expiring names database) may be hosted on a server and a network may communicatively couple the server, registered domain name database, and expiring domain names database.

The above features and advantages of the present inventions will be better understood from the following detailed description taken in conjunction with the accompanying drawings.

### BRIEF DESCRIPTION OF THE DRAWINGS

FIG. 1 is a flow diagram illustrating a possible embodiment of a method for jointly auctioning expiring domain names.

FIG. 2 is a flow diagram illustrating a possible embodiment of a method for jointly auctioning expiring domain names.

FIG. 3 is a flow diagram illustrating a possible embodiment of a method for jointly auctioning expiring domain names.

FIG. 4 is a flow diagram illustrating a possible embodiment of a method for jointly auctioning expiring domain names.

FIG. 5 is a flow diagram illustrating a possible embodiment of a method for jointly auctioning expiring domain names.

FIG. 6 is a flow diagram illustrating a possible embodiment of a method for jointly auctioning expiring domain names.

FIG. 7 is a flow diagram illustrating a possible embodiment of a method for jointly auctioning expiring domain names.

FIG. 8 illustrates a possible embodiment of a system for jointly auctioning expiring domain names.

FIG. 9 illustrates a possible embodiment of a system for jointly auctioning expiring domain names.

FIG. 10 illustrates a possible embodiment of a system for jointly auctioning expiring domain names.

FIG. 11 illustrates a possible embodiment of a system for jointly auctioning expiring domain names.

### DETAILED DESCRIPTION

The present inventions will now be discussed in detail with regard to the attached drawing figures which were briefly described above. In the following description, numerous specific details are set forth illustrating the Applicant's best mode for practicing the inventions and enabling one of ordinary skill in the art to make and use the inventions. It will be obvious, however, to one skilled in the art that the present inventions may be practiced without many of these specific details. In other instances, well-known machines, structures, and method steps have not been described in particular detail in order to avoid unnecessarily obscuring the present inventions. Unless otherwise indicated, like parts and method steps are referred to with like reference numerals.

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers place multimedia information (e.g., text, graphics, audio, video, animation, and other forms of data) at specific locations on the Internet referred to as webpages. Websites comprise a collection of connected, or otherwise related, webpages. The combination of all the websites and their corresponding webpages on the Internet is generally known as the World Wide Web (WWW) or simply the Web.

For Internet users and businesses alike, the Internet continues to be increasingly valuable. More people use the Web for everyday tasks, from social networking, shopping, banking, and paying bills to consuming media and entertainment. E-commerce is growing, with businesses delivering more services and content across the Internet, communicating and collaborating online, and inventing new ways to connect with each other.

Prevalent on the Web are multimedia websites, some of which may offer and sell goods and services to individuals and organizations. Websites may consist of a single webpage, but typically consist of multiple interconnected and related webpages. Websites, unless extremely large and complex or have unusual traffic demands, typically reside on a single server and are prepared and maintained by a single individual or entity. Menus and links may be used to move between different webpages within the website or to move to a different website as is known in the art. The interconnectivity of webpages enabled by the Internet can make it difficult for Internet users to tell where one website ends and another begins.

Websites may be created using HyperText Markup Language (HTML) to generate a standard set of tags that define how the webpages for the website are to be displayed. Users of the Internet may access content providers' websites using software known as an Internet browser, such as MICROSOFT INTERNET EXPLORER or MOZILLA FIREFOX. After the browser has located the desired webpage, it requests and receives information from the webpage, typically in the form of an HTML document, and then displays the webpage content for the user. The user then may view other webpages at the same website or move to an entirely different website using the browser.

Browsers are able to locate specific websites because each website, resource, and computer on the Internet has a unique Internet Protocol (IP) address. Presently, there are two standards for IP addresses. The older IP address standard, often called IP Version 4 (IPv4), is a 32-bit binary number, which is typically shown in dotted decimal notation, where four 8-bit bytes are separated by a dot from each other (e.g., 64.202.167.32). The notation is used to improve human readability. The newer IP address standard, often called IP Version 6 (IPv6) or Next Generation Internet Protocol (IPng), is a 128-bit binary number. The standard human readable notation for IPv6 addresses presents the address as eight 16-bit hexadecimal words, each separated by a colon (e.g., 2EDC:BA98:0332:0000:CF8A:000C:2154:7313).

IP addresses, however, even in human readable notation, are difficult for people to remember and use. A Uniform Resource Locator (URL) is much easier to remember and may be used to point to any computer, directory, or file on the Internet. A browser is able to access a website on the Internet through the use of a URL. The URL may include a Hypertext Transfer Protocol (HTTP) request combined with the website's Internet address, also known as the website's domain name. An example of a URL with a HTTP request and domain name is: http://www.companyname.com. In this example, the “http” identifies the URL as a HTTP request and the “companyname.com” is the domain name.

Domain names are much easier to remember and use than their corresponding IP addresses. The Internet Corporation for Assigned Names and Numbers (ICANN) approves some Generic Top-Level Domains (gTLD) and delegates the responsibility to a particular organization (a “registry”) for maintaining an authoritative source for the registered domain names within a TLD and their corresponding IP addresses. For certain TLDs (e.g., .biz, .info, .name, and .org) the registry is also the authoritative source for contact information related to the domain name and is referred to as a “thick” registry. For other TLDs (e.g., .com and .net) only the domain name, registrar identification, and name server information is stored within the registry, and a registrar is the authoritative source for the contact information related to the domain name. Such registries are referred to as “thin” registries. Most gTLDs are organized through a central domain name Shared Registration System (SRS) based on their TLD.

The process for registering a domain name with .com, .net, .org, and some other TLDs allows an Internet user to use an ICANN-accredited registrar to register their domain name. For example, if an Internet user, John Doe, wishes to register the domain name “mycompany.com,” John Doe may initially determine whether the desired domain name is available by contacting a domain name registrar. The Internet user may make this contact using the registrar's webpage and typing the desired domain name into a field on the registrar's webpage created for this purpose. Upon receiving the request from the Internet user, the registrar may ascertain whether “mycompany.com” has already been registered by checking the SRS database associated with the TLD of the domain name. The results of the search then may be displayed on the webpage to thereby notify the Internet user of the availability of the domain name. If the domain name is available, the Internet user may proceed with the registration process. Otherwise, the Internet user may keep selecting alternative domain names until an available domain name is found.

Domain names are typically registered for a period of one to ten years with first rights to continually re-register the domain name. When its registration expires, a domain name may be released back into the pool of available domain names, at which time it may be registered by another registrant via any domain name registrar for the standard registration fee. The domain name, however, may possess higher market value than the standard registration fee, perhaps due to a well-known website that previously resolved from it.

Applicant has determined that presently-existing systems and methods do not provide optimal means for domain name registrars (or others) to identify expiring domain names and, prior to domain name expiration, agree with domain name registrants to jointly sell the domain name for a predetermined fee and, once sold, share the fee in accordance with the agreement. For these foregoing reasons, there is a need for the systems and methods for jointly auctioning expiring domain names and related functionality as described herein.

Methods For Jointly Auctioning Expiring Domain Names

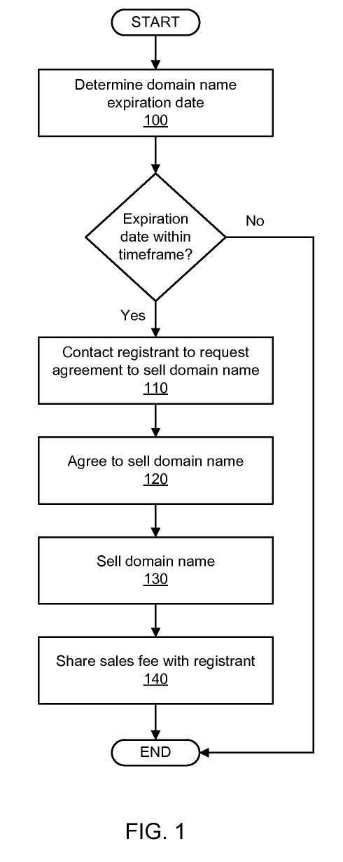

FIG. 1 illustrates a possible embodiment of a method for jointly auctioning expiring domain names that may comprise determining whether an expiration date of at least one domain name is within a predetermined timeframe (Step 100). If the expiration date is within the predetermined timeframe, the domain name registrant may be contacted (Step 110), prior to the expiration date, with a request for an agreement to jointly sell the domain name for a fee and to share the fee. If the parties reach an agreement (Step 120) prior to the expiration date, they may jointly sell the domain name (Step 130) and share the fee (Step 140).

Step 100 may be accomplished by any method known in the art or developed in the future of determining whether a domain name's registration has expired. As a non-limiting example, Step 100 may be performed by a server running software and/or scripts that, when executed by the server's microprocessor, search a database storing domain name registration data to identify a domain name's expiration date and determine whether it falls within a predetermined timeframe. The predetermined timeframe may comprise any period of time having a starting and ending time (e.g., Jan. 1, 2009 to Feb. 1, 2009, the next two weeks, or the next 7 days).

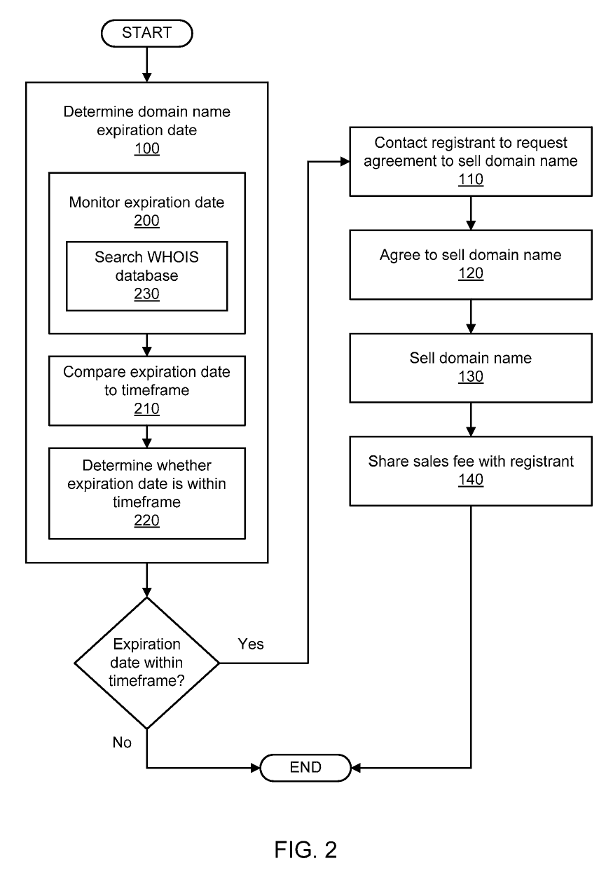

As illustrated in FIG. 2, Step 100 also may be accomplished, perhaps by the server, software, and/or scripts described above, by monitoring (at regular intervals) the domain name's expiration date (Step 200), comparing the expiration date to the predetermined timeframe (Step 210), and determining whether the expiration date falls within the predetermined timeframe (Step 220). As a non-limiting example, the domain name's expiration date may be monitored by searching, perhaps on a daily basis, a WHOIS records database containing domain name registration data, including the domain name's expiration date.

WHOIS records may be maintained by a domain name registry, registrar, and/or another party and are readily accessible over the Internet. WHOIS is a TCP-based query/response protocol that is widely used for querying a database in order to determine the owner of a domain name, an IP address, or an autonomous system number on the Internet. “Thin” registries store limited amount of information about a domain name; typically, it includes the domain Name, registrar, WHOIS server, referral URL, name server, status, updated date, creation date, expiration date, etc. “Thick” registries in addition store registrant, administrative, technical, and billing contact information.

Alternatively, a registrar may determine the expiration date (Step 100) of domain names under the registrar's management by searching the registrar's own internal database or by querying the registry through the SRS system. If the domain name's expiration date is determined to fall outside the predetermined timeframe (i.e., the domain name's registration does not expire before the end of the predetermined timeframe), the process may end. If Step 100 results in a determination that the domain name's expiration date falls within the predetermined timeframe (i.e., the domain name's registration expires before the end of the predetermined timeframe), the domain name's registrant may be contacted (Step 110) to request an agreement to jointly sell his domain name to a third party and to share any resultant fee.

The registrant may be contacted via any method known in the art or developed in the future including, but not limited to sending an electronic communication to the registrant, perhaps over a network such as the Internet. As non-limiting examples, an electronic communication sent to the registrant may comprise any electronic file generated by an Internet forum software application, an instant messaging software application, an electronic discussion group software application, an email software application, a weblog software application, a Short Message Service (SMS) software application, a Multimedia Messaging Service (MMS) software application, a text messaging software application, a video messaging software application, a picture messaging software application, or any combination thereof. Or the registrant simply may be called (e.g., over a public-switched telephone network), perhaps by a person or an automated calling means, such as a software application running on a server with Voice Over Internet Protocol (VOIP) functionality.

The parties then may agree to jointly sell the domain name (Step 120). The agreement may be reached prior to the domain name's expiration date and may be made via any of the methods discussed above including, but not limited to, a return electronic communication from the registrant (e.g., email, SMS, or text messaging) or a telephone discussion. For example, an email sent to the registrant during the contacting step (Step 110) may comprise a link to a website, which itself may comprise an agreement form having a plurality of terms and conditions governing the agreement, including the specifics of how the fee may be shared. The fee may be shared with the registrant—as non-limiting examples—according to a fixed, non-negotiated percentage (e.g., 10% of the sales price), a flat fee (e.g., $25 per transaction), a negotiated percentage, and/or any other fee sharing arrangement. The website listing the agreement's terms and conditions may have a mechanism allowing the registrant to agree to the terms and bind himself contractually. Such mechanism may comprise a click-through agreement, data fields, dialog boxes, drop-down menus, lists, etc., allowing the registrant to agree to the terms and conditions or, alternatively, modify the terms and submit them for agreement.

The domain name then may be sold to a third party (Step 130) by any method known in the art or developed in the future including, but limited to, selling the domain name via a server and over a network such as the Internet. As a non-limiting example, the domain name may be listed and sold on a domain name auction website, such as GODADDY.COM's GODADDY AUCTIONS service. Once sold, the resultant sales fee may be shared with the registrant pursuant to the terms of the agreement (Step 140). The fee may be paid to the registrant in any manner including, but not limited to mailing a check, wire transfer, direct deposit into an account, and/or providing account credit.

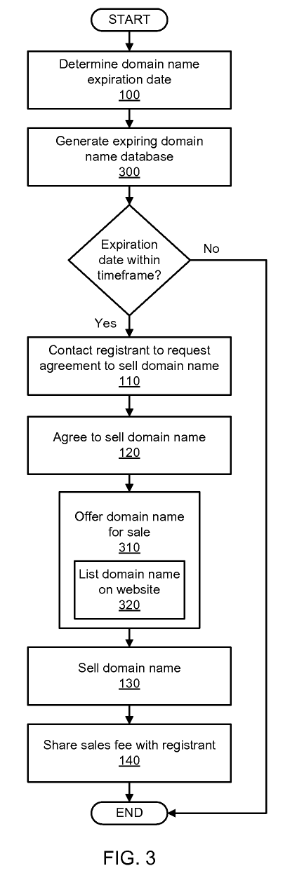

FIG. 3 illustrates another embodiment of a method for jointly auctioning expiring domain names that, in addition to the steps described above, may further comprise the step of generating an expiring domain name database for storing at least one of the domain names whose expiration date falls within the predetermined timeframe (step 300). The database may be generated at anytime, including prior to contacting the registrant (Step 110) and may comprise, as non-limiting examples, a local database, online database, desktop database, server-side database, relational database, hierarchical database, network database, object database, object-relational database, associative database, concept-oriented database, entity-attribute-value database, multi-dimensional database, semi-structured database, star schema database, XML database, file, collection of files, spreadsheet, or other means of data storage located on a computer, client, server, or any other storage device known in the art or developed in the future. This expiring domain names database may provide a single accessible location on the network at which all domain names determined to be expiring may be stored.

The method illustrated in FIG. 3 may also include the step of, prior to selling the domain name to a third party (Step 130), offering at least one of the domain names stored in the expiring domain names database for sale (Step 310), perhaps by listing them on a domain name sales website (Step 320) that may have shopping cart functionality (e.g., GODADDY.COM QUICK SHOPPING CART). The website may list for sale one or more of the domain names in the expiring domain names database, such as the above-described GODADDY AUCTIONS service. Alternatively, any method of offering the expiring domain names stored in the expiring domain name database may be used including, but not limited to listing the domain names for sale in print, broadcast, or any other advertising media.

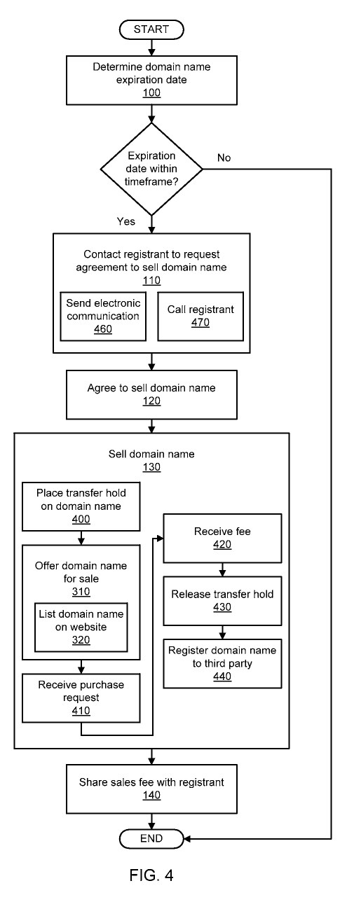

FIG. 4 illustrates another embodiment of a method for jointly auctioning expiring domain names wherein, in addition to the steps described above, the step of contacting the registrant (Step 110) may be accomplished by, as described in detail above, sending an electronic communication to the registrant (Step 460) and/or calling the registrant over a public switched telephone network (Step 470). In this example embodiment, the domain name may be sold (Step 130) by placing a transfer hold on the expiring domain name (Step 400), offering the domain name for sale (Step 310), receiving—from a third party—a request to purchase the domain name (Step 410), receiving a sales fee from the third party (Step 420), releasing the transfer hold on the domain name (Step 430), and registering the domain name to the third party (Step 440). This example embodiment places no limitation upon the sequence that Steps 400 through 440 are accomplished, so long as they result in selling the domain name to the third party (Step 130).

A transfer hold may be placed on the domain name (Step 400) by any method known in the art or developed in the future for locking a domain name such that its registrant cannot transfer its control to another individual or entity. As a non-limiting example, a transfer hold may be placed on a domain name by setting its status code to “REGISTRAR-LOCK,” or any other status code that may preclude transfer control of the domain name (e.g., “REGISTRY-LOCK,” REGISTRY-HOLD,” “REGISTRAR-HOLD,” etc.). These methods may generally be completed by the domain name's registry (perhaps via the SRS system) or registrar. The transfer hold may comprise a flag that the registrar may set in its own database. Accordingly, if a transfer request is received from the registry, the flag may be checked and, if the flag is set to preclude transfer, the transfer request may be denied. A registrar also may place a transfer hold by setting the status code (perhaps via a SRS request at the registry level) to “REGISTRAR-LOCK” or “REGISTRAR-HOLD.” Both such status codes may result in the registry denying the transfer request. Alternatively, the domain name registrant may place a transfer hold by selecting the “DOMAIN LOCK” feature offered by many registrars via a control panel that allows registrants to manage features of their domain names. This type of lock may be implemented locally within the registrar's own database or systems.

After a purchase request is received from a third party (Step 410) (perhaps via a domain name auction website) and the domain name sales fee is received (Step 420) (perhaps via a charge to the third party's credit card or deposit account), the transfer hold on the domain name may be released (Step 430). As non-limiting examples, this may be accomplished by resetting the domain name's status code to “ACTIVE,” or any other status code that may permit transfer control of the domain name. If the registrant locked his domain name via a “DOMAIN LOCK” feature offered by his registrant, he may simply release the lock. Once the transfer lock is released, the domain name is available for registration and may then be registered to the third party (Step 440) by any method known in the art or developed in the future for registering a domain name including, but not limited to those discussed in detail above.

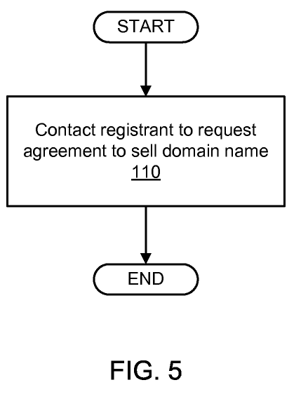

FIG. 5 illustrates a streamlined embodiment of a method for jointly auctioning expiring domain names that may be performed by at least one microprocessor executing a plurality of instructions stored on at least one computer-readable media, comprising the step of: contacting, prior to at least one domain name's registration expiration date (and via a network such as the Internet), at least one domain name registrant to request an agreement to jointly sell the domain name for a fee and to share the fee (Step 110). As a non-limiting example, the registrant may be contacted when the expiration date falls within a predetermined timeframe via any of the methods discussed in detail above including, but not limited to, sending an electronic communication (Step 460) and/or calling the registrant on the telephone (Step 470).

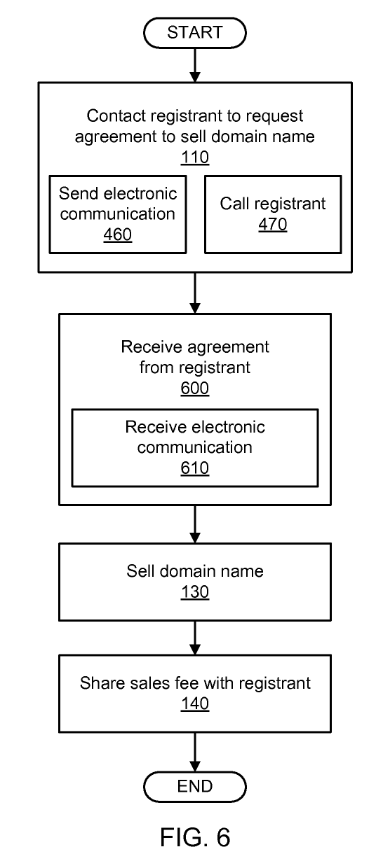

FIG. 6 builds upon the embodiment illustrated in FIG. 5 by adding the step of receiving, perhaps via the network, an agreement from the domain name registrant to jointly sell the domain name and to share the resulting sales fee (Step 600). The agreement may be received electronically (Step 610) via any of the communication methods discussed in detail above including, but not limited to email, Internet forum, instant messaging, weblog, SMS, MMS, text messaging, video messaging, picture messaging, telephone communication, or any combination thereof. For example, an email sent to the registrant during the contacting step (Step 110) may comprise a link to a website, which may comprise an agreement form having a plurality of terms and conditions governing the agreement, including the specifics of how the fee may be shared. The website listing the agreement's terms and conditions may also comprise a mechanism, such as described above, allowing the registrant to agree to the terms and bind himself contractually. If the parties reach an agreement (Step 120) prior to the expiration date, they may jointly sell the domain name (Step 130) and share the fee (Step 140).

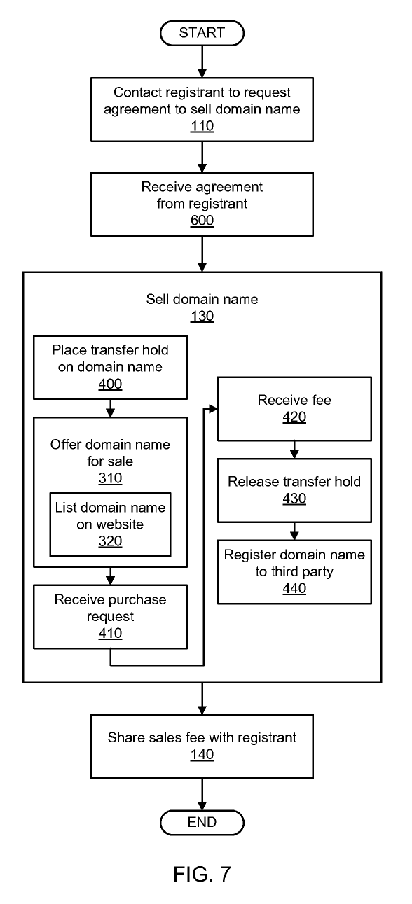

FIG. 7 illustrates yet another alternate embodiment wherein, as described in detail above, the domain name may be sold (Step 130) by placing a transfer hold on the expiring domain name (Step 400), offering the domain name for sale (Step 310), receiving—from a third party—a request to purchase the domain name (Step 410), receiving a sales fee from the third party (Step 420), releasing the transfer hold on the domain name (Step 430), and registering the domain name to the third party (Step 440). This example embodiment places no limitation upon the sequence through which Steps 400 through 440 are accomplished, so long as they result in selling the domain name to the third party (Step 130).

Systems for Jointly Auctioning Expiring Domain Names

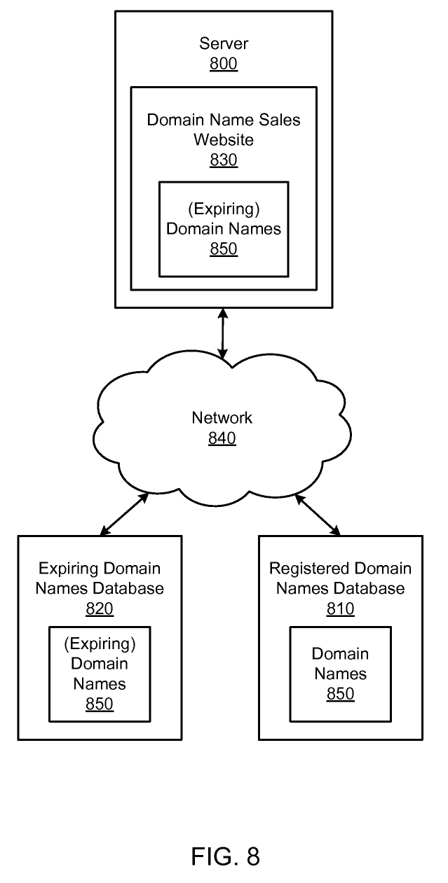

FIG. 8 illustrates a streamlined embodiment of a system for jointly auctioning expiring domain names that may comprise: at least one server 800 configured to: (1) determine whether an expiration date of at least one domain name 850 stored in a registered domain name database 810 is within a predetermined timeframe; and (2) contact a registrant of each domain name 850 expiring within the predetermined timeframe to request an agreement to jointly sell the domain name 850 and to share the fee. The system also may comprise an expiring domain names database 820 storing at least one domain name 850 having a registration expiring within a predetermined timeframe and a domain name sales website 830 hosted on the at least one server 800. The domain name sales website 830 may list for sale at least one domain name 850 stored in the expiring domain names database 820. A network 840 may communicatively couple the at least one server 800, the registered domain name database 810, and the expiring domain names database 820.

The example embodiments herein place no limitation on network 840 configurations or connectivity. Thus, as non-limiting examples, the network 840 could comprise the Internet, a public switched telephone network, a global Telex network, computer networks (e.g., an intranet, an extranet, a local-area network, or a wide-area network), wired networks, wireless networks, or any combination thereof. All system components described herein may be communicatively coupled to the network 840 via any method of network connection known in the art or developed in the future including, but not limited to wired, wireless, modem, dial-up, satellite, cable modem, Digital Subscriber Line (DSL), Asymmetric Digital Subscribers Line (ASDL), Virtual Private Network (VPN), Integrated Services Digital Network (ISDN), X.25, Ethernet, token ring, Fiber Distributed Data Interface (FDDI), IP over Asynchronous Transfer Mode (ATM), Infrared Data Association (IrDA), wireless, WAN technologies (Ti, Frame Relay), Point-to-Point Protocol over Ethernet (PPoE), and/or any combination thereof.

The at least one server 800, and/or any other server described herein, could be any computer or program that provides services to other computers, programs, or users either in the same computer or over a computer network. As non-limiting examples, the server 800 could be an application, communication, mail, database, proxy, fax, file, media, web, peer-to-peer, or standalone server and may use any server format known in the art or developed in the future (possibly a shared hosting server, a virtual dedicated hosting server, a dedicated hosting server, or any combination thereof).

As explained above, the at least one server 800 may be configured to (1) determine whether an expiration date of at least one domain name 850 stored in a registered domain name database 810 is within a predetermined timeframe; and (2) contact a registrant of each domain name 850 expiring within the predetermined timeframe to request an agreement to jointly sell the domain name 850 and to share the fee. The configuration may be accomplished by installing software programmed with instructions stored on a computer-readable storage medium, the instructions which, when executed by the first server 800, cause it to complete Steps 100 and 110, which are described in detail above. Alternatively, scripts (a program or sequence of instructions that is interpreted or carried out by another program) may be written and implemented allowing the server's 800 operating system to accomplish these steps. As a non-limiting example, such software and/or scripts may determine the domain name's 850 expiration date by monitoring at regular intervals (perhaps daily) the domain name's 850 expiration date (perhaps by searching a WHOIS records database), comparing the expiration date to—and determining whether it falls within—the predetermined timeframe.

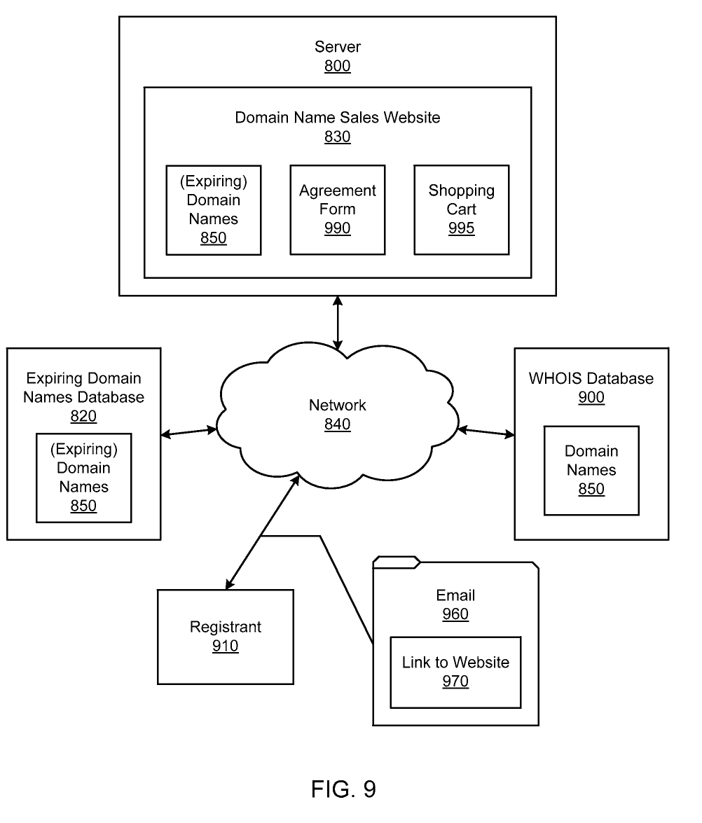

Both the registered domain names database 810 and the expiring domain names database 820 may, as non-limiting examples, a local database, online database, desktop database, server-side database, relational database, hierarchical database, network database, object database, object-relational database, associative database, concept-oriented database, entity-attribute-value database, multi-dimensional database, semi-structured database, star schema database, XML database, file, collection of files, spreadsheet, or other means of data storage located on a computer, client, server, or any other storage device known in the art or developed in the future. The registered domain name database 810 may comprise any data storage mechanism accessible via the network 840 that may store data regarding registered domain names including, but not limited to, a complete list of registered domain names 850 and an associated registration expiration date. As illustrated in FIG. 9, the registered domain names database 810 may comprise WHOIS records. The expiring domain names database 820 may comprise any data storage mechanism accessible via the network 840 that may store data regarding domain names 850 that may expire within a predetermined timeframe, possibly as determined by software and/or scripts running on the server 800.

A domain name sales website 830 may be hosted on the at least one server 800 and may comprise any collection of data and/or files accessible via a browser on a client having access to the network 840. Examples of clients that may be used include a desktop computer, a laptop computer, a hand held computer, a terminal, a television, a television set top box, a cellular phone, a wireless phone, a wireless hand held device, an Internet access device, a rich client, thin client, or any other client functional with a client/server computing architecture. As non-limiting examples, the domain name sales website 830 may comprise a single webpage or multiple interconnected and related webpages, each of which may provide access to multimedia content (e.g., text files, audio files, video files, graphics files, executable files, etc.). The domain name sales website 830 also may comprise a list of expiring domain names 850, perhaps as determined by software and/or scripts running on the server 800, that may be offered for sale to a third party. As a non-limiting example, the domain name may be listed and sold on a domain name auction website, such as GODADDY.COM's GODADDY AUCTIONS service.

FIG. 9 illustrates an alternate embodiment of a system for jointly auctioning expiring domain names, wherein an email 960 sent to the registrant 910 during the contacting step (Step 110) may comprise a link 970 to the domain name sales website 830, which itself may comprise an agreement form 990 having a plurality of terms and conditions governing the agreement. The form 990 may include the specifics of how the fee may be shared including, but not limited to, the example fee-sharing arrangements described in detail above (e.g., according to a fixed, non-negotiated percentage, a flat fee, or a negotiated percentage).

The website 830 listing the agreement's terms and conditions may have a mechanism allowing the registrant 910 to agree to the terms and bind himself contractually. Such mechanism may comprise a click-through agreement, data fields, dialog boxes, drop-down menus, lists, etc., allowing the registrant 910 to agree to the terms and conditions or, alternatively, modify the terms and submit them for agreement. The domain name sales website 830 also may have a shopping cart 995 (e.g., GODADDY.COM QUICK SHOPPING CART) allowing third parties to purchase the expiring domain names 850 listed on the website 830.

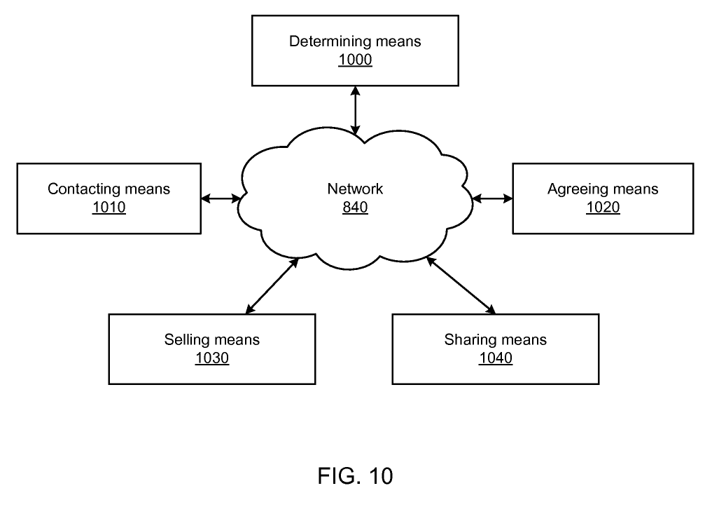

FIG. 10 illustrates another embodiment of a system for jointly auctioning expiring domain names comprising: means for determining 1000 whether an expiration date of at least one domain name 850 is within a predetermined timeframe, means for contacting 1010 (if the expiration date is within the predetermined timeframe) the domain name's 850 registrant 910 to request an agreement to jointly sell the domain name 850 for a fee and to share the fee, means for agreeing 1020 with the registrant 910 to jointly sell the domain name 850, means for selling 1030 the domain name 850 to a third party, means for sharing 1040 the fee with the registrant 910, and a network 840 communicatively coupling each of these means (1000 through 1040). Each of the means described in this paragraph may be implemented via any system known in the art or developed in the future for accomplishing the step associated with the means including, but not limited to, the systems described in detail elsewhere in this specification.

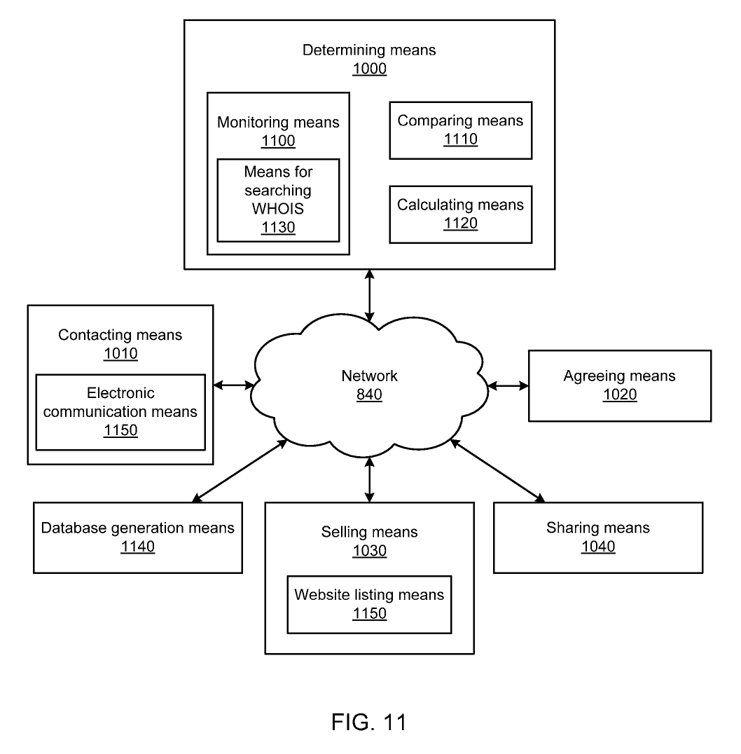

FIG. 11 builds upon the embodiment illustrated in FIG. 10. In this example embodiment, the determining means 1000 may further comprise: means for monitoring 1100 (perhaps at regular intervals) the expiration date of the domain name 850 (perhaps via means for searching 1130 a WHOIS records database 900), means for comparing 1110 the expiration date to the predetermined timeframe, and means for calculating 1120 whether the expiration date is within the predetermined timeframe. This illustrated embodiment also may comprise means for generating 1140 an expiring domain name database 820 (communicatively coupled to the network) for storing domain names 850 whose expiration dates fall within the predetermined timeframe. Moreover, the selling means 1030 may further comprise means for listing 1150 on a domain name sales website 830 the expiring domain names 850 that may be stored in the expiring domain names database 820, and the contacting means 1010 may further comprise means for sending 1150 an electronic communication, such as an email 960, to the registrant 910. Each of the means described in this paragraph may be implemented via any system known in the art or developed in the future for accomplishing the step associated with the means including, but not limited to, the systems described in detail elsewhere in this specification.

Other embodiments and uses of the above inventions will be apparent to those having ordinary skill in the art upon consideration of the specification and practice of the inventions disclosed herein. The specification and examples given should be considered exemplary only, and it is contemplated that the appended claims will cover any other such embodiments or modifications as fall within the true scope of the inventions.

The Abstract accompanying this specification is provided to enable the United States Patent and Trademark Office and the public generally to determine quickly from a cursory inspection the nature and gist of the technical disclosure and in no way intended for defining, determining, or limiting the present inventions or any of its embodiments.

1. A method, comprising the steps of:
A) determining, by at least one server, whether an expiration date of at least one domain name is within a predetermined timeframe;
B) upon a determination that said expiration date is not within said predetermined timeframe, ending said method; and
C) upon a determination that said expiration date is within said predetermined timeframe:
i) transmitting an electronic request, prior to said expiration date and via a network, to a registrant of said at least one domain name, said electronic request requesting an agreement to jointly sell said at least one domain name for a fee and to share said fee;
ii) receiving an electronic communication, prior to said expiration date and via said network, from said registrant, said electronic communication comprising said agreement to jointly sell said at least one domain name to a third party for said fee and to share said fee;
iii) selling, via said at least one server, said at least one domain name to said third party; and
iv) sharing said fee with said registrant.

2. The method of claim 1, wherein said determining step A) comprises the steps of:
i) monitoring at regular intervals said expiration date of said at least one domain name;
ii) comparing said expiration date to said predetermined timeframe; and
iii) determining whether said expiration date is within said predetermined timeframe.

3. The method of claim 2, wherein said monitoring step A) i) is accomplished by searching a WHOIS records database for said expiration date.

4. The method of claim 2, wherein said monitoring step A) i) is accomplished by searching a registrar's internal database for said expiration date.

5. The method of claim 2, wherein said monitoring step A) i) is accomplished by querying a registry via a Shared Registration System.

6. The method of claim 2, wherein said regular interval comprises a daily interval.

7. The method of claim 1, further comprising the step of: prior to contacting step C) i): generating an expiring domain name database storing each of said at least one domain name whose expiration date is within said predetermined timeframe and not storing each of said at least one domain name whose expiration date falls outside of said predetermined timeframe.

8. The method of claim 7, further comprising the step of, prior to selling step C) iii): offering for sale at least one domain name stored in said expiring domain names database.

9. The method of claim 8, wherein said offering for sale step further comprises the step of: listing on a domain name sales website each domain name in said expiring domain names database.

10. The method of claim 9, wherein said selling step C) iii) is accomplished via said domain name sales website, said domain name sales website having a shopping cart.

11. The method of claim 1, wherein said selling step C) iii) comprises the steps of:
a) placing a transfer hold on said at least one domain name;
b) offering said at least one domain name for sale;
c) receiving a request to purchase said at least one domain name from said third party;
d) receiving said fee from said third party;
e) releasing said transfer hold on said at least one domain name; and
f) registering said at least one domain name to said third party.

12. The method of claim 11, wherein said offering for sale step further comprises the step of: listing said at least one domain name for sale on a domain name sales website.

13. The method of claim 1, wherein said network is selected from the group consisting of the Internet, a public switched telephone network, a global Telex network, a computer network, an intranet, an extranet, a local-area network, a wide-area network, a wired network, and a wireless network.

14. The method of claim 13, wherein said contacting step C) i) comprises the step of: sending an electronic communication to said registrant.

15. The method of claim 14, wherein said electronic communication comprises an email.

16. The method of claim 15, wherein said email comprises a link to a website.

17. The method of claim 16, wherein said website comprises an agreement form comprising a plurality of terms and conditions of said agreement.

18. The method of claim 13, wherein said contacting step C) i) comprises the step of: calling said registrant over a public switched telephone network.

19. The method of claim 18, wherein said calling step is accomplished via a telephone.

20. The method of claim 18, wherein said calling step is accomplished by an automated calling means.

21. The method of claim 1, wherein said fee is shared with said registrant according to a fixed, non-negotiated percentage.

22. The method of claim 1, wherein said fee is shared with said registrant according to a negotiated percentage.

23. A method performed by at least one microprocessor executing a plurality of instructions stored on at least one computer-readable media, said method comprising the step of: contacting, prior to an expiration date of at least one domain name and via an electronic communication transmitted via a network, at least one registrant of said least one domain name to request an agreement to jointly sell said domain name for a fee and to share said fee, wherein said expiration date falls within a predetermined timeframe.

24. The method of claim 23, further comprising the step of receiving, via said network, agreement from said at least one registrant to jointly sell said domain name for said fee and to share said fee.

25. The method of claim 24, further comprising the steps of: selling, over said network, said domain name to a third party and sharing said fee with said registrant.

26. The method of claim 25, wherein said network is selected from the group consisting of the Internet, a public switched telephone network, a global Telex network, a computer network, an intranet, an extranet, a local-area network, a wide-area network, a wired network, and a wireless network.

27. The method of claim 26, wherein said contacting step comprises the step of: sending an electronic communication to said registrant.

28. The method of claim 27, wherein said electronic communication comprises an email.

29. The method of claim 28, wherein said email comprises a link to a website.

30. The method of claim 29, wherein said website comprises an agreement form comprising a plurality of terms and conditions of said agreement.

31. The method of claim 25, wherein said contacting step comprises the step of: calling said registrant over a public switched telephone network.

32. The method of claim 31, wherein said calling step is accomplished via a telephone.

33. The method of claim 31, wherein said calling step is accomplished by an automated calling means.

34. The method of claim 27, wherein said receiving agreement step comprises the step of: receiving an electronic communication from said registrant.

35. The method of claim 34, wherein said electronic communication comprises an email.

36. The method of claim 25, wherein said fee is shared with said registrant according to a fixed, non-negotiated percentage.

37. The method of claim 25, wherein said fee is shared with said registrant according to a negotiated percentage.

38. The method of claim 25, wherein said selling step comprises the steps of:
i) placing a transfer hold on said at least one domain name;
ii) offering said at least one domain name for sale;
iii) receiving a request to purchase said at least one domain name from said third party;
iv) receiving said fee from said third party;
v) releasing said transfer hold on said at least one domain name; and
vi) registering said at least one domain name to said third party.

39. The method of claim 38, wherein said selling step further comprises the step of: listing said at least one domain name for sale on a domain name sales website having a shopping cart.

40. A method, comprising the steps of:
A) monitoring, once per day by at least one server, an expiration date of at least one domain name by searching a WHOIS records database;
B) determining, by said at least one server, whether said expiration date is within a predetermined timeframe;
C) upon a determination that said expiration date is not within said predetermined timeframe, ending said method;
D) upon a determination that said expiration date is within said predetermined timeframe:
i) generating, by said at least one server, an expiring domain name database accessible via the Internet comprising each of said at least one domain name whose expiration date is within said predetermined timeframe;
ii) sending, by said server via the Internet, an email to a registrant of said at least one domain name, said email requesting an agreement to jointly sell said at least one domain name for a fee and to share said fee and comprising a link to an agreement form comprising a plurality of terms and conditions of said agreement;
E) receiving said agreement from said registrant via an electronic communication transmitted over the Internet;
F) selling, via said at least one server, said domain name to a third party by:
i) placing a transfer hold on said at least one domain name;
ii) offering said at least one domain name for sale by listing said at least one domain name for sale on a domain name sales website;
iii) receiving a request to purchase said at least one domain name from said third party;
iv) receiving said fee from said third party;
v) registering said at least one domain name to said third party; and
vi) releasing said transfer hold on said at least one domain name; and
G) sharing said fee with said registrant.
